(19) United States
(12) Patent Application Publication
(10) Pub. No.: US 2005/0237853 A1
(43) Pub. Date: Oct. 27, 2005

(54) Mixer

(75) Inventors: Bryan Louis Martel, Nevada City, CA (US); Robert Donald Villwock, Grass Valley, CA (US); Bruce Edward Welch, Elk Grove, CA (US); Joseph Richard Cochran, Grass Valley, CA (US); Joshua Eli Een, Grass Valley, CA (US)

Correspondence Address: Kristin C. Castle, 3691 East Curtis Drive, Sacramento, CA, 95818, US

(73) Assignee: Mobius Technologies, Inc.

(21) Appl. No.: 11/090,695

(22) Filed: Mar. 24, 2005

Related U.S. Application Data
(62) Division of application No. 10/412,607, filed on Apr. 10, 2003.
(60) Provisional application No. 60/372,270, filed on Apr. 11, 2002.

(51) Int. Cl. B01F 7/22; B01F 7/24

(52) U.S. Cl. 366/266; 366/264; 366/307

(57) ABSTRACT

The disclosed device is directed towards a mixer apparatus comprising a barrel defining an interior and an exterior. The barrel has a first end and a second end opposite thereof. The barrel defines at least one inlet proximate to the first end and an outlet proximate to the second end. A motor unit is in operative communication with the barrel. A moving element is disposed in the interior of the barrel. The moving element is configured to move material through the barrel to the outlet of the barrel. At least one first mixing element is fluidly coupled to the outlet.

### PRIORITY CLAIM

This application is a divisional application of application Ser. No. 10/412,607 which claims priority to Provisional Patent Application No. 60/372,270 filed on Apr. 11, 2002.

### BACKGROUND

The present invention relates to mixing devices and more particularly, to a mixing apparatus for mixing powdered solids into liquids.

Polyurethane foam can be ground into fine particles using, for example, cryogenic processes or roll mills. These fine particles can then be used, for example, to replace chemicals in recipes for new polyurethane or new foam; this provides an environmental benefit and often a cost savings. “Polyurethane” (PUR) describes a general class of polymers prepared by polymerization of diisocyanate molecules and one or more active-hydrogen compounds. “Active-hydrogen compounds” include polyfunctional hydroxyl-containing (or “polyhydroxyl”) compounds such as diols, polyester polyols, and polyether polyols. Active-hydrogen compounds also include polyfunctional amino-group-containing compounds such as polyamines and diamines. An example of a polyether polyol useful in recipes for flexible polyurethane foam is a glycerin-initiated polymer of ethylene oxide or propylene oxide.

In order to add polyurethane powder to the recipe, the powder must be mixed with liquid reactants to form a slurry. Although the powder may be mixed with any of the liquid reactants—such as polyol, diisocyanate, water, surfactants, catalysts, and the like—it is generally preferred to mix the powder into the one or more liquid reactants that comprise the largest fraction of the mass of the recipe. This recipe component with the most mass is usually polyol. Polyols are described in considerable detail in “Polyurethane Handbook, 2nd ed.,” Gunter Oertel, Hanser/Gardner Publications, Inc., 1993, pages 55 to 72. Further, the slurry must be free of entrained bubbles because they create an undesirable irregular cell structure in the foam, including holes and splits. Powder can be mixed with liquid reactants in a batch process by adding a known mass of powder to a known mass of polyol, mixing thoroughly, and allowing sufficient time (generally about 8 to 48 hours) for entrained bubbles to leave the slurry. Such a natural de-gassing process takes a long time because the slurry has a high viscosity, generally about 500 to 20,000 mPa-s. The slurry viscosity increases with powder concentration, and concentrated slurries can have a viscosity in excess of 20,000 mPa-s. A continuous process for removal of entrained air is preferred over a batch process because the continuous process would not require waiting for entrained air to leave the slurry naturally, and the continuous processes would not require the large storage capacity necessary to hold the slurry needed for an entire day of foam production.

A need exists for devices and processing methods to take solid particles, for example finely ground polyurethane-foam particles, disperse them as a slurry in polyol, remove substantially all entrained bubbles from the slurry, and to use this slurry as a direct replacement for at least some of the chemicals in the production of new polyurethane articles. It is further desirable for such a process to be able to run continuously, such that powder and polyol are mixed, de-gassed, and used to make new polyurethane articles without delay. The desired continuous process must be able to deliver bubble-free slurry with an accurately controlled solids concentration at an accurately controlled flow rate.

### SUMMARY

The present system comprises devices, methods and an integrated process for the continuous production of substantially bubble-free slurries of solid powders in liquids and for the delivery of such slurries at an accurately controlled concentration and flow rate. The devices comprise a mixer and a mixer assembly.

Powder and liquid (for example, finely ground polyurethane, melamine, calcium carbonate, barium sulfate, talc, and/or carbon black powder and polyol liquid) are delivered continuously to a mixer where they are contacted intimately and a slurry is produced. The slurry, which may contain entrained air bubbles, is delivered from the mixer to a de-gassing step, where entrained bubbles are continuously removed. The mixer is designed to mix into a vessel of liquid (for example, polyol) a low-bulk-density solid that has a tendency to float (for example, finely ground polyurethane foam).

The mixer drives the solids under the surface of the liquid in a tank, for example using an auger, breaks up clumps of powder that otherwise tend to float rapidly because they hold interstitial air, and provides at least one impeller to disperse, mix and wet the powder. The mixer is integrated into a tank, which is optionally provided with internal baffles to promote transfer of powder to the fluid, and an internal screen to retain any un-dispersed clumps of powder until they are fully wet out and dispersed. A slurry can be produced continuously with the mixer by delivering powder at a known, controlled rate to the mixer, delivering polyol at a known, controlled rate to the tank, and drawing the slurry away from the vessel. A slurry produced continuously in this way can be delivered to intermediate storage, or can be used directly in subsequent processes. A process for removal of entrained bubbles is one example, or the manufacture of polyurethane foam is another example of subsequent processes.

The disclosed device is directed towards a mixer apparatus comprising a barrel defining an interior and an exterior. The barrel has a first end and a second end opposite thereof. The barrel defines at least one inlet proximate to the first end and an outlet proximate to the second end. A motor unit is in operable communication with the barrel. A moving element is disposed in the interior of the barrel. The moving element is configured to move material through the barrel to the outlet of the barrel. At least one first mixing element is fluidly coupled to the outlet.

Another embodiment disclosed is directed towards a mixer assembly. The mixer assembly comprises a tank including a side wall disposed between a top of the tank and a bottom of the tank opposite thereof. The tank has an interior and an exterior defined by the side wall, the top and the bottom of the tank. The tank includes an inlet and an outlet. A discharge partition is mounted at the interior of the tank proximate to the outlet. A mixer comprises a barrel defining an interior and an exterior. The barrel has a first end and a second end opposite thereof. The barrel defines at least one inlet proximate to the first end and an outlet proximate to the second end. A motor unit is in operable communication with the barrel. A moving element is disposed in the interior of the barrel. The moving element is configured to move material through the barrel to the outlet of the barrel. At least one first mixing element is fluidly coupled to the outlet.

The method disclosed comprises delivering powder and liquid to the mixer to produce a slurry. Powder is delivered to the mixer at a known, controlled rate. For example, a loss-in-weight feeder may be used. The mixer drives the powder under the surface of the slurry in the mix tank. Polyol is delivered to the mix tank at a known, controlled rate. For example, a non-cavitating, positive-displacement pump may be used, or the polyol delivery rate can be measured with a flowmeter. The mixer disperses and wets out the powder. Mixed slurry is continuously drawn from the bottom of the mix tank at a rate substantially equivalent to the total rate of addition of powder and polyol.

Another method is disclosed comprising inserting at least one material into at least one inlet of the mixer assembly. The at least one inlet is formed in a barrel having a first end and a second end opposite thereof. The method includes transferring the at least one material through the barrel to an outlet, the outlet is formed in the barrel proximate the second end. The method includes discharging the at least one material through the outlet into a liquid, the liquid being contained in a tank coupled to the barrel, wherein the barrel is mounted in the tank. The method includes breaking up lumps of the at least one material discharged from the outlet with a lump breaker. The method includes inserting the liquid into the tank. The method includes maintaining a liquid level of the liquid in the tank above the outlet. The method includes mixing the liquid and the at least one material in the tank to form a slurry employing at least one mixing element. The method includes recirculating at least one of the at least one material and the lumps of the material to the at least one mixing element for mixing into the liquid to form the slurry. The method includes passing the slurry through a discharge partition mounted proximate to a tank outlet, wherein the discharge partition includes apertures configured to block unmixed materials. The method includes discharging the slurry through a tank outlet.

### BRIEF DESCRIPTION OF THE ATTACHED DRAWINGS

FIG. 1 is an illustration of an exemplary mixer.

FIG. 2 is a detail of FIG. 1 of exemplary components of the mixer.

FIG. 3 is an illustration of an exemplary mixer assembly.

### DETAILED DESCRIPTION

A mixing apparatus is disclosed. The mixer is designed to mix materials (i.e., powder and liquid) delivered to the mixer to produce a slurry. Material, such as at least one powder, is delivered to the mixer at a known, controlled rate. The mixer drives the material to or under the surface of the slurry in a mix tank. At least one liquid (e.g., polyol) is delivered to the mix tank at a known, controlled rate as well. The mixer disperses and wets out the powder. Mixed slurry is continuously drawn from the bottom of the mix tank at a rate substantially equivalent to the total rate of addition of powder and polyol.

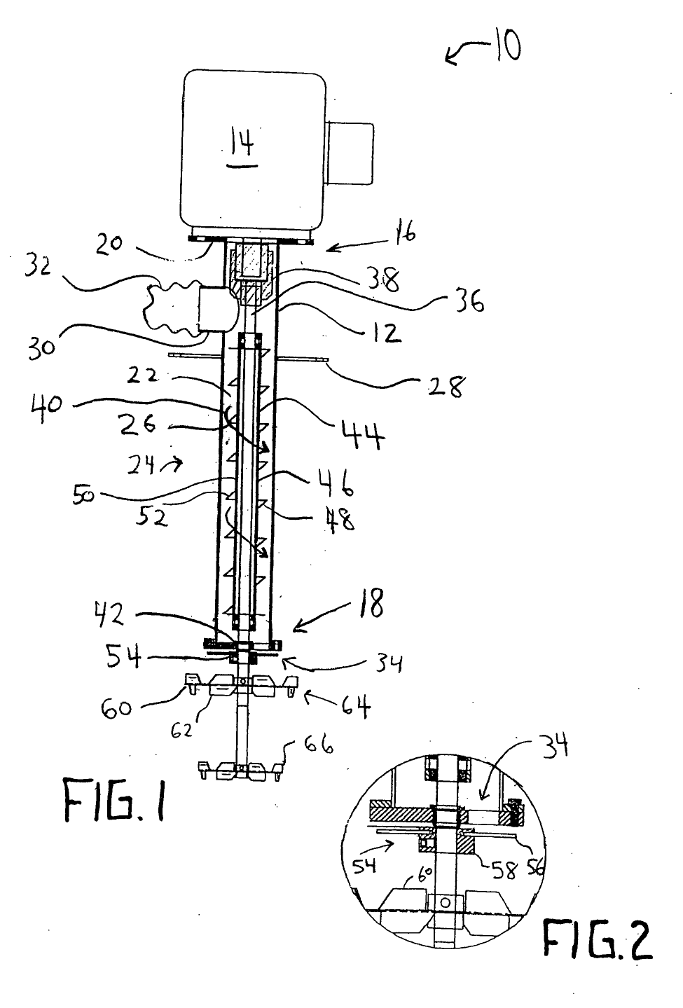

Referring now to FIGS. 1 and 2, an exemplary mixer is illustrated. The mixer 10 comprises a barrel 12 coupled to a motor unit 14. The barrel 12 is configured to receive and process materials. In a preferred embodiment, the barrel 12 comprises steel material and has, for example, a length of 100 centimeters and a diameter of 18 centimeters, or a length of 80 centimeters and a diameter of 10 centimeters. It is contemplated that other materials such as plastics and other metals and other dimensions can be employed depending on the mass flow rates of the process and the materials to be processed. The motor unit 14 is in operative communication with the barrel 12 at a first end or top of the barrel 16. The motor unit 14 is illustrated as being coupled to the barrel at the top end 16, however it is contemplated that the motor unit 14 can also be coupled to stationary components in other orientations and is not limited to merely coupling to the top 16 of the barrel 12. The motor unit 14 includes a motor drive shaft 15 extending out of the motor unit 14 into the barrel 12. A second end or bottom of the barrel 18 is opposite the top of the barrel 16. In an exemplary embodiment, a mounting flange 20 at the top of the barrel 16 couples the motor unit 14 to the barrel 12. The barrel 12 defines an interior of the barrel 22 and an exterior of the barrel 24. The powder materials are initially processed at the interior 22 along a flow path 26 (indicated with arrows). A tank-mounting flange 28 is formed at the exterior 24 and configured to mount to various fluid vessels (not shown). The barrel 12 includes an inlet 30 located proximate to the top of the barrel 16. In exemplary embodiments, more than one inlet 30 can be employed. The inlet 30 is configured to receive materials to be processed. The inlet 30 is illustrated at an orthogonal relationship to the barrel 12. In exemplary embodiments, inlet 30 can be angled with respect to the barrel 12 to provide for efficient material transfer and low flow resistance into the interior 22. In exemplary embodiments, the material can flow through the inlet 30 by gravity or by mechanical means and any combination thereof. The inlet 30 can be straight bore, constant diameter or funneled or tapered in shape to maximize material transfer. A flexible coupling 32 can connect the material supply to the inlet 30 of the barrel 12. Multiple inlets 30 for addition of multiple materials are contemplated. For example, solid materials such as calcium carbonate, melamine, barites, talc, carbon black, flame retardants, or polyurethane powder could be added as blends through inlet 30 or could be added via separate inlets for different solid materials. An outlet 34 is located at the bottom of the barrel 18 and configured to pass material out of the barrel 12.

The motor unit 14 motor drive shaft 15 is coupled to a mixing shaft 36 via a coupling 38. The motor unit 14 imparts rotary motion to the mixing shaft 36. A lower bearing 42 is shown supporting the mixing shaft 36 proximate to the bottom of the barrel 18. The lower bearing 42 can be integrated into the outlet 34 allowing for rotary support as well as proper mass flow rate out of the barrel 12. In an exemplary embodiment, the outlet 34 is configured as a webbing including the lower bearing 42 contained and supported central to the webbing (not shown). The outlet 34 can be configured to support the lower bearing 42 and discharge the material at a constant rate. In another exemplary embodiment, the mixer 10 can employ only one bearing in a cantilever configuration allowing for the outlet to have a configuration that does not require mounting the lower bearing 42.

A moving element 44 is coupled to the mixing shaft 36. In an exemplary embodiment the moving element 44 is coupled to the mixing shaft above the lower bearing 42. The moving element 44 is configured to push, drive, and flow materials along the flow path 26 of the interior 22 of the barrel 12 from the inlet 30 to the outlet 34. The moving element 44 rotates within the interior 22. It is contemplated that the moving element 44 can be coupled to alternate shafts (not shown) and separated from the shafts driving other rotary components. In an exemplary embodiment, the moving element 44 is an auger 46 having blades or flights 48 formed to impart motion to the materials along the flow path 26. In other embodiments, the moving element can include at least one helical paddle along the length of the moving element 44 or partially along the moving element 44. The moving element 44 is specially configured to move fine powdered materials having light weight and being particularly clingy to surfaces of the interior of the barrel 22 and the moving element 44. The moving element 44 can include surfaces that are durable and have low friction coefficients with respect to the material being processed. The paddles or blades 48 extend into the interior 22 away from the mixing shaft 36 at a distance sufficient to impart motion to the material, as well as clear material that may cling to the barrel 12 at the interior of the barrel 22. In alternative exemplary embodiments, the moving element 44 can comprise a fan 50 and fan blades 52. The fan 50 can be rotated at sufficient rates to move materials through the flow path 26. The mixer 10, in exemplary embodiments, injects or otherwise disposes the materials at and/or below the surface of liquids in order to limit entrapping air as well as to improve blending and mixing qualities in the process. Thus it is contemplated that the mixer 10 can be oriented vertically from above a liquid and disposing the barrel 12 into the liquid or oriented along side a liquid horizontally and disposing the barrel 12 into the liquid or oriented vertically below the liquid and disposing the barrel into the liquid wherein the barrel includes seals as well as a positive pressure with respect to the liquid and any combination thereof. In yet another exemplary embodiment, the moving element 44 can include a driving fluid 40 flowing through the flow path 26. The driving fluid 40 can be directed along the flow path 26 and/or directed from the inlet 30 toward the outlet 34 driving the material out of the barrel 12. The driving fluid 40 can include the liquid to be mixed with the material as well as other fluids that can be combined.

Referring to both FIGS. 1 and 2, an exemplary lump breaker 54 is illustrated. The lump breaker 54 is coupled to the mixing shaft 36 proximate to the outlet 34. In a preferred embodiment, the lump breaker 54 includes pins 56 mounted in a disc 58. The pins 56 are configured in a spaced apart pattern that promotes the reduction of larger clumps or lumps of material passing out of the outlet 34 while avoiding or (otherwise imparting a minimum amount of) centrifugal forces that would propel the material outwardly and away from proximity to the mixing shaft 36. In alternate exemplary embodiments, the pins 56 can be blades, fins and pins and any combination thereof. In another embodiment, the lump breaker can comprise a perforated or slotted disk. In another embodiment, the lump-breaker 54 can comprise a radial arrangement of stiff pins 56 affixed around a central hub 58. The pins 56 are long enough to span the entire opening of outlet 34.

A mixing element such as an impeller 60 is coupled to the mixing shaft 36 proximate to the outlet 34 and distal from the lump breaker 54. The impeller 60 includes impeller blades 62 formed on the impeller 60. In an exemplary embodiment, the mixing element 60 can comprise a high-shear mixer 64. The high-shear mixer 64 can grind, disperse and mix the materials to be processed. In a preferable embodiment, at least one impeller is a radial-flow high-shear dispersion impeller. In other embodiments, the mixing element 60 comprises one or more radial-flow impellers, such as disks or Rushton-type impellers. In other embodiments, an axial-flow impeller (for example, marine impellers or pitched-blade turbines, or helical agitators) can provide higher flow and more tank turnovers. In other embodiments, the mixing element 60 comprises a rotor-stator high-shear mixer. It is contemplated that more than one or additional mixing elements 66 can be coupled to the mixing shaft 36 proximate to the outlet 34 and distal from the mixing element 60. The additional mixing elements or simply impellers 66 also mix and chop materials to be processed. The additional impellers 66 can be located and arranged to blend and flow materials back into the impeller 60.

In an exemplary embodiment, the moving element 44 can be separately coupled to an additional shaft (not shown). The mixing element 60 can be separately coupled to the mixing shaft 36 as well as the lump breaker 54. In alternate embodiments, the mixing element 60, lump breaker 54 and moving element 44 can be coupled to individual shafts as well and any combination of shafts and rotated at various rates in various directions.

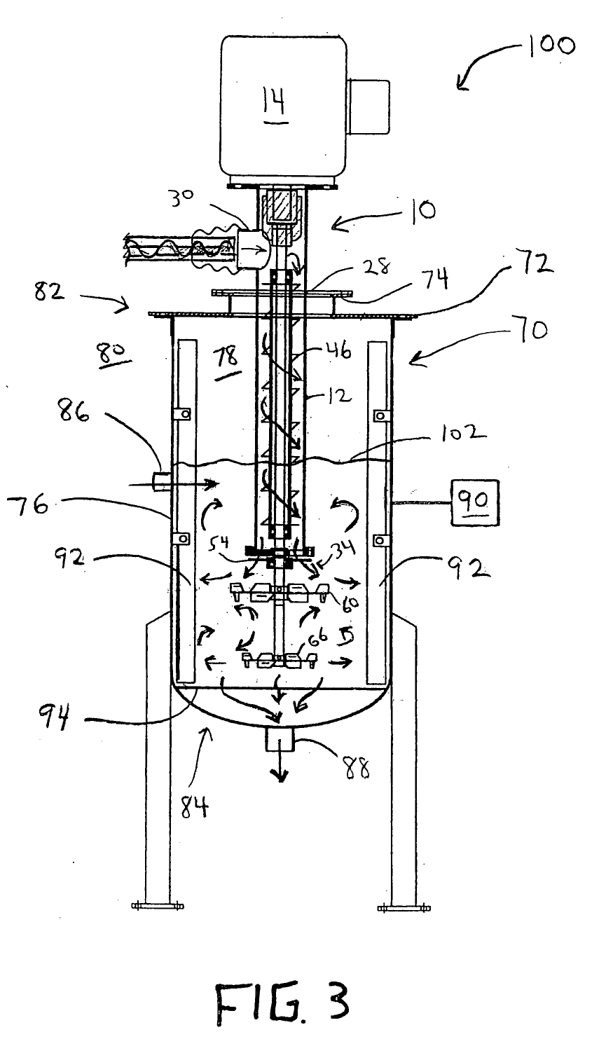

FIG. 3 illustrates the mixer assembly 100 in an exemplary embodiment. The mixer assembly 100 includes the mixer 10 installed into a mixing tank, or simply tank 70. The tank 70 includes a tank cover 72 having a flange 74 to couple the mixer 10 to the tank 70 via the tank mounting flange 28. The tank 70 and the contents are under atmospheric pressure under normal operating conditions. The tank 70 comprises a side wall 76 defining an interior of the tank 78 and an exterior of the tank 80. The side wall 76 and tank cover 72 are coupled at a top of the tank 82. A bottom of the tank 84 is coupled to the side wall 76 opposite of the top of the tank 82. A tank inlet 86 is formed in the side wall 76 between the top of the tank 82 and the bottom of the tank 84. In an exemplary embodiment, the tank inlet 86 is located above the bottom of the tank 84 about two-thirds up the side wall 76. The tank inlet 86 is configured to intake fluids, such as polyol to the interior of the tank 78. A tank outlet 88 is formed in the tank bottom 84. The tank outlet 88 is configured to allow for the discharge of materials from the interior of the tank 78.

The level and other parameters of the materials in the tank 70 can be monitored and controlled by instrumentation and controls 90 including level sensors, as well as temperature, viscosity, solids concentration, and entrained gas sensors, all generally shown as numeral 90.

The tank 70 can include baffles 92 at the interior 78 along the side wall 76. The baffles 92 can be configured to improve mixing in the tank 70 by improving transfer of mixing power to the fluid, creating fluid flows such as turbulence, eliminating vortexes, as well as blend the materials in the tank 70.

A discharge partition 94 can be located in the tank interior 78 proximate to the tank bottom 84. The discharge partition 94 includes perforations or holes formed in a plate in a pattern that allows for the slurry to pass through the discharge partition 94 while maintaining the unmixed lumps or partially mixed materials in the mixing tank interior 78 until properly mixed into the slurry. Preferably the openings in the discharge partition 94 have a size of from about 0.1 to about 1 cm. In another exemplary embodiment, the discharge partition 94 can be a perforated cap over the outlet 88. The cap can be a non-planar shape, such as cylindrical or spherical. The additional impellers 66 can be positioned proximate to the discharge partition 94 in order to blend and mix the slurry as well as to move the slurry into the impellers 60 for continued mixing.

The mixer assembly 100, in an exemplary embodiment, includes rotating the mixing shaft 36 by motor unit 14 through coupling 38. Auger 41, lump-breaker 54, and at least one impeller 60 are attached to and rotate with mixing shaft 36. Powder is added to the mixer 10 at a known, controlled rate through inlet 30. Flexible coupling 32 seals the inlet 30 to the perimeter of a powder feeder (not shown) in such a way as to avoid blowing dust while maintaining mechanical isolation of the mixer 10 from powder feeder (not shown). If the powder feeder is a loss-in-weight feeder, mechanical isolation of the feeder from the mix tank 70 is important so that the weight measurement is not biased. Powder drops through inlet 30 onto auger 46. The auger 46 rapidly moves the powder through barrel 12 to the outlet 34.

The outlet 34 of the barrel 12 is positioned at or below a working liquid level 102 in the tank 70. Powder exits outlet 34 and is rapidly dispersed into the surrounding liquid by lump-breaker 54. The lump-breaker 54 is positioned very close to the outlet 34 so that no large lumps of powder may pass without being broken into smaller elements.

Impellers 60 and 66 are positioned below the lump-breaker 54 and are of suitable size and design to provide multiple turnovers of the tank volume within the mean residence time of the powder. Preferably, one impeller 60 is placed near the lump-breaker for good mixing, and a second impeller 66 is placed near the bottom of the tank to avoid settling of solids.

The liquid component of the slurry (for example, polyol) is added to tank 70, preferably at a position near the working liquid level 102, by means of at least one inlet 86. The tank 70 preferably has a plurality of baffles 92 to reduce the formation of a vortex. Near the bottom of the tank 84, discharge partition 94 is attached. The discharge partition 94 has a plurality of openings that allow mixed slurry to pass through, but that returns larger un-dispersed lumps of powder for additional mixing. Mixed slurry leaves the mix tank through tank outlet 88 in the tank bottom 84.

In alternate embodiments, there can be multiple shafts rotating the moving element 44, the mixing element(s) 60 as well as the lump breaker 54 and any additional impeller(s) 66. The shafts can be disposed in the barrel 12, can be inserted into the tank 70 from the top of tank 82, from the bottom of tank 84 and/or through the side wall 76.

In anther embodiment, the material provided to the liquid for producing the slurry can be injected into the liquid at the surface of the liquid as well as below the surface of the liquid in the absence of entraining air into the slurry. The moving element 44 drives the material through the barrel 12 under the liquid level 102 or at the liquid level 102 even in the embodiment when the moving element 44 is a driving fluid 40.

While embodiments and applications of this disclosure have been shown and described, it would be apparent to those skilled in the art that many more modifications than mentioned above are possible without departing from the inventive concepts herein. The disclosure, therefore, is not to be restricted except in the spirit of the appended claims.

1. A method of mixing materials in a mixer assembly comprising;
inserting at least one material into at least one inlet of the mixer assembly, said at least one inlet formed in a barrel having a first end and a second end opposite thereof;
transferring said at least one material through said barrel to an outlet, said outlet formed in said barrel proximate to said second end;
discharging said at least one material through said outlet into a liquid, said liquid being contained in a tank coupled to said barrel, wherein said barrel is mounted in said tank;
breaking up lumps of said at least one material discharged from said outlet with a lump breaker;
inserting said liquid into said tank;
maintaining a liquid level of said liquid in said tank above said outlet;
mixing said liquid and said at least one material in said tank to form a slurry employing at least one mixing element;
recirculating at least one of said at least one material and said lumps of said material to said at least one mixing element for mixing into said liquid to form said slurry;
passing said slurry through a discharge partition mounted proximate to a tank outlet, wherein said discharge partition includes apertures configured to block unmixed materials; and
discharging said slurry through a tank outlet.

2. The method of claim 30 wherein said at least one material comprises finely ground polyurethane powder.

3. The method of claim 30 wherein said liquid comprises polyol.

4. The method of claim 30 wherein transferring said at least one material through said barrel to said outlet employs an auger.

5. The method of claim 30 wherein breaking up lumps of said material discharged from said outlet with a lump breaker includes maintaining transfer of said material toward said at least one mixing element.

6. The method of claim 30 wherein said at least one mixing element is a radial flow high-shear impeller.

7. The method of claim 30 wherein recirculating at least one of said at least one material and said lumps of said material employs a second mixing element located proximate to said discharge partition.

8. The method of claim 30 wherein maintaining a liquid level of said liquid in said tank above said outlet employs instrumentation and controls.

9. The method of claim 30 further comprising:
preventing the formation of a vortex in said tank.

10. The method of claim 38 wherein preventing the formation of said vortex includes employing baffles in said tank.

11. The method of claim 30 wherein transferring said at least one material through said barrel to said outlet employs a driving fluid.
